(19) United States
(12) Patent Application Publication
(10) Pub. No.: US 2006/0005008 A1
(43) Pub. Date: Jan. 5, 2006

(54) SECURITY GATEWAY UTILIZING SSL PROTOCOL PROTECTION AND RELATED METHOD

(76) Inventor: Wen-Hung Kao, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/904,470

(22) Filed: Nov. 11, 2004

(30) Foreign Application Priority Data
Jul. 2, 2004 (TW) 093119979

(51) Int. Cl. H04L 9/00

(52) U.S. Cl. 713/153

(57) ABSTRACT

A security gateway, for use in a network system for linking at least a client end and a server end, includes a user interface, a SSL VPN driver, a connection interface and an IPSEC VPN driver. The security gateway supports IPSEC and SSL protocols. Before establishing an IPSEC VPN between a client end and a server end, the security gateway will perform ID authentication for the user of the client end with a widely-used SSL protocol, so as to establish a SSL VPN between a server end and a client end. When the ID of the client end is authorized, a configuration file comprising the SA is generated and then safely sent to the client end through the SSL VPN tunnel. After the client end receives and executes the configuration file having the SA, an IPSEC VPN tunnel between the server end and the client end is established.

### BACKGROUND OF THE INVENTION

1. Field of the Invention

The present invention relates to a security gateway using an SSL protocol and a method thereof, more particularly, to a security gateway using both SSL and IPSEC protocols and the method thereof.

2. Description of the Prior Art

With the rapid development of network technology, packets loaded privacy information such as confidentiality, personal ID, and password, can be easily and quickly transmitted through a public network system (e.g. the Internet). However, a cunning hacker is able to intrude and intercept the data from the public network system. Therefore, it is a very important topic for maintaining the safety of transmitted data over public networks. Nowadays, various types of Internet appliances (IA) such as security gateways or firewall devices are developed. Through the use of a specific security standard (e.g. FTP, HTTP or Telnet etc.), such Internet appliances disposed at either a receiving end or a transmitting end of the network system can provide security for the data transmitted across the network system.

Furthermore, a Virtual Private Network Gateway (VPN Gateway) is available for providing a mechanism of a Virtual Private Network. Utilizing to such a mechanism, a VPN tunnel for transmitting private data can be established between a user computer system (located in a local area network) and a server computer system via a public network environment, such as the Internet or an Asynchronous Transfer Mode (ATM) network. Such VPN tunnel can serve as an Intranet or Extranet configured in an enterprise, having the convenience of a public network and the safety of an internal network. Therefore, the remote authorized user can respectively establish a unique connection tunnel with other users, firms, branches, agencies or clients to deliver important information over the Internet. For example, when an outside user computer system tries to access a computer system of a company (acting as a server computer system), VPN tunnels between VPN devices (e.g. gateways) are established by using tunneling techniques, such as IPSEC, PPTP, and L2TP to build a security tunnel as safe as an internal network in a public network (e.g. the Internet). This is because the private data packets from the user computer are encapsulated before being sent, and other mechanisms like certification, ID authentication or decryption/encryption are utilized, preventing packet-intercepting by hackers during transmission. In general, two kinds of decryption/encryption mechanisms are widely used: one is symmetrical Secret key cryptography and the other is asymmetrical Public key cryptography.

IPSEC, instituted by the Internet Engineering Task Force (IETF) in order to integrate various standards, is applied on an IP Layer of end-to-end communication by utilizing decryption/encryption, assuring the authentication, integrity, access control and confidentiality of data as it is transmitted between the client end and/or the server end. The IPSEC protocol contains a security association (SA) to be used for ID authentication, decryption/encryption algorithm communication, and gold key production. The security association (SA) of the VPN gateway complying with the IPSEC protocol is recorded into an IPSEC VPN unit (i.e. driver software/firmware), and each IPSEC VPN gateway corresponds to a different SA. Before establishing a two-way IPSEC VPN tunnel between the client end and the server end, both ends must hold mutual SAs. Because the IPSEC VPN gateway of the client end needs to receive and set configuration parameters from the IPSEC VPN gateway of the server end, some problems occur:

(1) Under the site-to-site network structure, configuration parameters of the SA corresponding to the IPSEC VPN gateway of the remote server end are transmitted to the IPSEC VPN gateway of the client end over the public network (e.g. the Internet), or IT operators may use telephones to exchange required configuration parameters, which lacks a protection mechanism, so that the configuration parameters of the SA are likely intercepted by hackers. Moreover, it is also very complicated and inconvenient for a rookie operator to set the configuration parameters of the SA.

(2) Under a remote access network structure, for example, if a user of a notebook computer intends to establish an IPSEC VPN tunnel with a remote sever end (e.g. a company), he/she needs to get the configuration parameters of the SA corresponding to the VPN gateway of the server end in advance by using the telephone or e-mail, and manually key-in such configuration parameters into the IPSEC VPN software installed in the notebook computer. This is also a very insecure way to fetch the SA.

### SUMMARY OF THE INVENTION

To solve the above-mentioned problem, the present invention provides a security gateway using both SSL and IPSEC protocols and a method thereof. The security gateway and the related method are for use in a client-to-server network structure. The present invention security gateway can support both SSL and IPSEC protocols. Before establishing an IPSEC VPN between a client end and a server end, an SSL VPN driver of the security gateway disposed at the server end will perform ID authentication for the user of the client end with a widely-used SSL protocol, so as to establish a SSL VPN between a server end and a client end. When the SSL VPN driver confirms the ID of the client end, thus, an IPSEC VPN between the server end and the client end is established. Meanwhile, a configuration file comprising the SA of the IPSEC VPN driver is generated by the SSL VPN driver and then safely sent to the client end through the SSL VPN tunnel, so that higher security for data transmission, especially the SA, is guaranteed. When receiving the configuration file having the SA, the user of the client end can enable it to set the SA, such that the IPSEC VPN tunnel between the server end and the client end can be established quickly and precisely.

According to the claimed invention, a security gateway for use in a network system for linking at least a client end and a server end is provided. The security gateway comprises a user interface for generating a web image via a web browser stored in the client end of the network system, the web image providing a remote auto-set access mechanism for being manipulated by the client end; an SSL VPN driver for establishing a SSL VPN tunnel between the server end and the client end over a network system as the remote auto-set access mechanism is activated, so that a certification data of the client end is capable of safely being transmitted to the SSL VPN driver through the SSL VPN tunnel; a connection interface for transmitting the certification data from the SSL VPN driver; and an IPSEC VPN driver for generating a security association (SA) based on the certification data transmitted from the connection interface, and for generating and sending information with the security association to the client end via the SSL VPN tunnel, so as to establish an IPSEC VPN tunnel.

According to claimed invention, a method of SSL protocol protection for use in a security gateway, for use in a network system for linking at least client end and a server end is provided, wherein the security gateway is at the server end. The method comprises the steps of generating a web image using a web browser of the client end through a user interface of the security gateway, the web image comprising a remote auto-set access mechanism for receiving an ID authentication data inputted by means of the web browser of the client end; activating the remote auto-set access mechanism of the web image showed by the web browser of the client end to drive the SSL VPN driver of the security gateway; establishing a SSL VPN tunnel between the server end and the client end, so that the ID authentication data of the client end is sent to the SSL VPN driver of the security gateway through the SSL VPN tunnel; the SSL VPN driver determining if the received ID authentication data is authorized to establish an IPSEC VPN tunnel between the client end and the server end; if the ID authentication data is authorized, requesting the client end to send a certification data to the IPSEC VPN driver of the security gateway via the SSL VPN tunnel, for establishing the IPSEC VPN tunnel; the IPSEC VPN driver generating a security association (SA) based on the certification data, and sending the SA back to the client end via SSL VPN tunnel; and the client end setting the SA and establishing an IPSEC VPN tunnel between client end and the server end.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a first embodiment of a security gateway used in a client-to-server structure according to the present invention.

FIG. 2 shows a second embodiment of a security gateway used in a client-to-server structure according to the present invention.

FIGS. 3 and 4 are sequence flowcharts of the method illustrating SSL protocol protection with the security gateway depicted in FIGS. 1 and 2.

### DETAILED DESCRIPTION

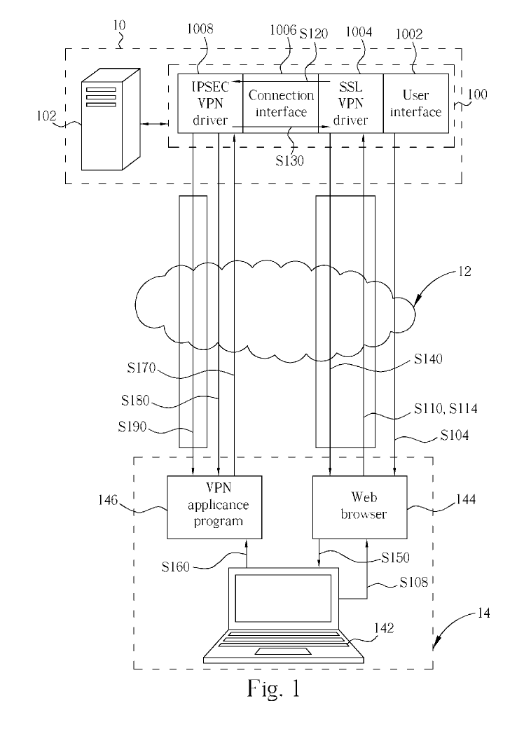

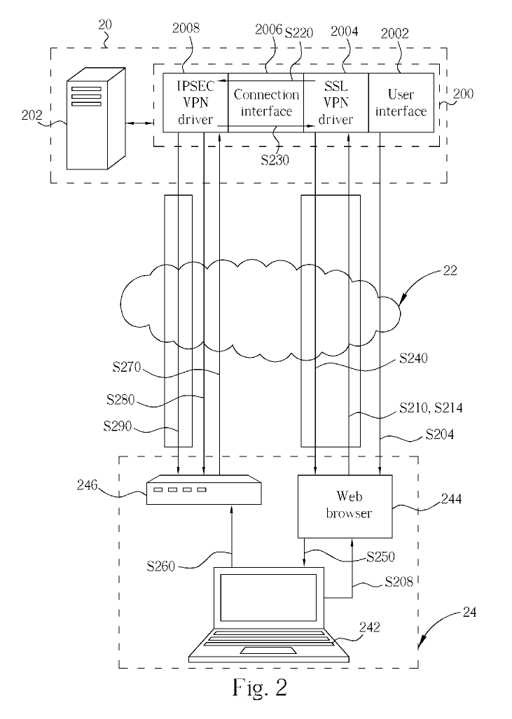

Please refer to FIG. 1, which shows a first preferred embodiment of a security gateway 100 according to the present invention. The security gateway 100 supports both SSL (Secured Socket Layer) and IPSEC protocols, which is for use in a network architecture, such as the Internet 12, for linking a server end 10 and a client end 14. The security gateway 100 comprises a user interface 1002, an SSL VPN driver 1004, a connection interface 1006 and an IPSEC VPN driver 1008. In addition, the security gateway 100 disposed with a computer system 102 (e.g. a server) regards as the server end 10, and the client end 14 further includes a computer system 142 (e.g. a notebook computer) and a web browser 144 supporting SSL protocol corresponds to the SSL VPN driver 1004 of the security gateway 100, so as to establish a SSL VPN tunnel between the server end 10 and the client end 14. The client end 14, 24 respectively contains an IPSEC VPN appliance program 146 or an IPSEC VPN gateway 246 (as shown in FIG. 2) corresponding to the IPSEC VPN driver 1008 of the security gateway 100, so as to establish an IPSEC VPN tunnel between the server end 10 and the client end 14.

The user interface (UI) 1002 of the security gateway 100 produces a web image on a web browser 144 of the computer system 142 via the Internet 12. The web image provides a remote auto-set access mechanism. As activated by the user of the client end 14, the remote auto-set access mechanism requests the user to input an ID authentication data via the web browser 144, and then sends the ID authentication data to the SSL VPN driver 1004 of the security gateway 100 for SSL protocol ID authentication. The ID authentication data contains personal accounts and passwords, which are authorized to access the server end 10.

The SSL VPN driver 1004, in this embodiment, can be a VPN driving firmware supporting SSL protocol, which is used for protecting data transmission over the application layer under SSL protocol. As activated, the remote auto-set access mechanism requests the SSL VPN driver 1004 to establish a SSL VPN tunnel between the server end 10 and the client end 14 over the Internet 12, so that the ID authentication data can be safely sent to the SSL VPN driver 1004 via the SSL VPN tunnel. When receiving the ID authentication data, the SSL VPN driver 1004 determines if the ID authentication data of the client end 14 is authorized to determine establishing an IPSEC VPN tunnel between the client end 14 and the server end 10, which is used for accessing and transmitting the privacy data, e.g. confidentiality of a firm. If it is, the web browser 144 notifies the client end 14 of sending a certification data, such as the IP address of the client end 14, gold key, or certificate etc., to the SSL VPN driver 1004 via the SSL VPN tunnel. The certification data can be detected by the computer system 102, 142 or uploaded by the user. On the contrary, if the ID authentication data is not authorized, the SSL VPN driver 1004 will send an alarm message to the client end 14 not to establish the IPSEC VPN tunnel.

In this embodiment, the connection interface 1006 is a socket for controlling the data transmission between application layer and the IP layer, as well as data (including the certification data) transmitted between the SSL VPN driver 1004 and the IPSEC VPN driver 1008.

The IPSEC VPN driver 1008 can be a VPN driving firmware supporting IPSEC protocol, which is used for protecting data transmission over the IP layer. The IPSEC VPN driver 1008 generates a SA based on the certification data sent from the connection interface 1006, forms an executable configuration file having SA, and then sends back it to the client end 14 via the SSL VPN tunnel.

When receiving and executing the configuration file, the IPSEC VPN gateway 246 (as shown in FIG. 2) or the appliance program 146 (as shown in FIG. 1) will perform the associated SA setting for the client end 14, thereby establishing an IPSEC VPN tunnel between the client end 14 and the server end 10.

Please refer to FIG. 2, which shows a second embodiment of a security gateway 200 according to the present invention. Similarly to the first embodiment security gateway 100, the security gateway 200 is also for use in the Internet 22 for linking a client end 24 and a server end 20, except for an IPSEC VPN gateway 246 disposed in the client end 24, rather than the IPSEC VPN appliance program 146.

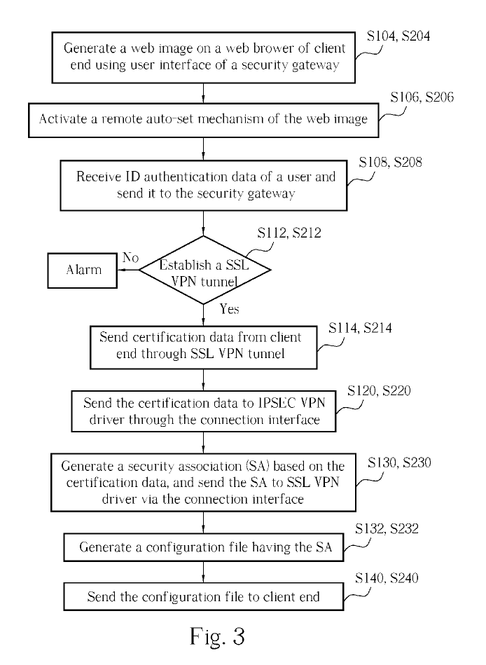

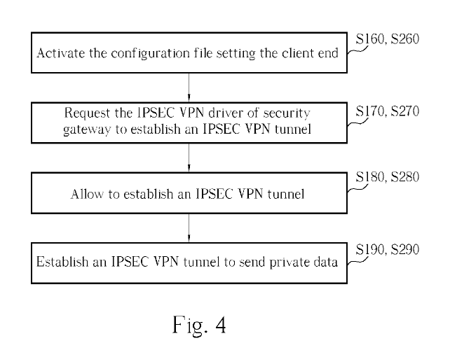

FIGS. 3 and 4 show sequence flowcharts of the SSL protection method using the security gateway 100, 200 depicted in FIGS. 1 and 2 according to the present invention. The steps of the methods occur:

Step S104, S204: A specific web image supporting SSL protocol is generated by the web browser 144, 244 of the computer system 142, 242 through the user interface 1002, 2002 of the server end 10, 20. The web image contains a remote auto-set access mechanism.

Step S106, S206: The remote auto-set access mechanism sends a message to request the user of the client end 14, 24 to input ID authentication data.

Step S108, S208: The remote auto-set access mechanism receives the ID authentication data and then sends it to the SSL VPN driver 1004 of the security gateway 100, 200.

Step S110, S210: The SSL VPN driver 1004, 2004 establishes a SSL VPN tunnel between the server end 10, 20 and the client end 14, 24, when the remote auto-set access mechanism is activated. Therefore, the ID authentication data can be sent to the SSL VPN driver 1004, 2004 via the SSL VPN tunnel.

Step S112, S212: The SSL VPN driver 1004, 2004 determines if the ID authentication data from the client end 14, 24 is authorized to establish an IPSEC VPN tunnel between the client end 14, 24 and the server end 10, 20.

Step S114, S214: If the ID authentication data is authorized, indicating that the SSL VPN driver 1004, 2004 allows to establish IPSEC VPN tunnel with the client end 14, 24, the certification data from the client end 14, 24 can be transmitted to the SSL VPN driver 1004, 2004 via the SSL VPN tunnel. On the contrary, if the ID authentication data is not authorized, send an alarm message to the web browser 144, 244 of the client end 14, 24, indicating that establishing the IPSEC VPN tunnel is not allowed.

Step S120, S220: The SSL VPN driver 1004, 2004 send the certification data to the IPSEC VPN driver 1008, 2008 of the security gateway 100, 200 through the connection interface 1006, 2006.

Step S130, S230: The IPSEC VPN driver 1008, 2008 generates a SA based on the certification data, and then sends the SA to the SSL VPN driver 1004, 2004 through the connection interface 1006, 2006.

Step S132, S232: The SSL VPN driver 1004, 2004 generates an executable configuration file having the SA.

Step S140, S240: Send the configuration file having the SA to the computer system 142, 242 of the client end 14, 24 through the SSL VPN tunnel.

Step S160, S260: The computer system 142, 243 executes the configuration file having the SA to do the SA setting with the IPSEC VPN gateway 246 (as shown in FIG. 2) or the IPSEC VPN appliance program 146 (as shown in FIG. 1).

Step S170, S270: The client end 14, 24, based on the SA, sends a request to the IPSEC VPN driver 1008 to establish an IPSEC VPN tunnel between the server end 10, 20 and the client end 14, 24.

Step S180, S280: The IPSEC VPN driver 1008, 2008 of the security gateway 100, 200 allows the client end 14, 24 to establish an IPSEC VPN connection; and

Step S190, S290: An IPSEC VPN connection between the client end 14, 24 and the server end 10, 20 is established, so as to transmit privacy data.

To sum up, the present invention security gateway can support both SSL and IPSEC protocols. Before establishing an IPSEC VPN between a client end and a server end, a SSL VPN driver of the security gateway disposed at the server end will perform ID authentication for the user of the client end with the widely-used SSL protocol, so as to establish a SSL VPN between a server end and a client end. When the SSL VPN driver confirms the ID of the client end, thus, an IPSEC VPN between the server end and the client end is established. Meanwhile, a configuration file comprising the SA of the IPSEC VPN driver is generated by the SSL VPN driver and then safely sent to the client end through the SSL VPN tunnel, so that higher security for data transmission, especially SA, is guaranteed. When receiving the configuration file having SA, the user of the client end can enable it to set the SA, such that the IPSEC VPN tunnel between the server end and the client end can be established quickly and precisely.

Those skilled in the art will readily observe that numerous modifications and alterations of the device and the method may be made while retaining the teachings of the invention. Accordingly, the above disclosure should be construed as limited only by the metes and bounds of the appended claims.

What is claimed is:

1. A security gateway for use in a network system for linking at least a client end and a server end, comprising:
a user interface for generating a web image via a web browser stored in the client end of the network system, the web image providing a remote auto-set access mechanism for being manipulated by the client end;
an SSL VPN driver for establishing a SSL VPN tunnel between the server end and the client end over a network system as the remote auto-set access mechanism is activated, so that a certification data of the client end is capable of safely being transmitted to the SSL VPN driver through the SSL VPN tunnel;
a connection interface for transmitting the certification data from the SSL VPN driver; and
an IPSEC VPN driver for generating a security association (SA) based on the certification data transmitted from the connection interface, and for generating and sending information with the security association to the client end via the SSL VPN tunnel, so as to establish an IPSEC VPN tunnel.

2. The security gateway of claim 1, wherein the client end further comprises an IPSEC VPN gateway or an IPSEC VPN appliance program corresponding to the IPSEC VPN driver of the security gateway disposed at the server end.

3. The security gateway of claim 2, wherein the web browser of the client end supports the SSL protocol so as to correspond to the SSL VPN driver of the security gateway.

4. The security gateway of claim 3, wherein the remote auto-set access mechanism requests the client end to input an ID authentication data by means of the web browser when activated, and sends the ID authentication data to the SSL VPN driver of the security gateway, wherein the ID authentication data comprises a password.

5. The security gateway of claim 4, wherein ID authentication data of the client end is sent by means of the SSL VPN to the SSL VPN driver of the security gateway.

6. The security gateway of claim 5, wherein the SSL VPN driver determines if the received ID authentication data is authorized so as to allow establishing an IPSEC VPN tunnel between the client end and the server end.

7. The security gateway of claim 6, wherein if the ID authentication data is authorized, the SSL VPN driver requests the client end to send the certification data to the SSL VPN driver via the SSL VPN tunnel.

8. The security gateway of claim 7, wherein the certification data comprises the Internet Protocol (IP) address of the client end, gold key or credential.

9. The security gateway of claim 1, wherein the IPSEC VPN driver is a VPN driving firmware supporting IPSEC protocol for protecting data transmission over the IP layer.

10. A method of SSL protocol protection for use in a security gateway, for use in a network system for linking at least client end and a server end, wherein the security gateway is at the server end, the method comprising:
generating a web image using a web browser of the client end through a user interface of the security gateway, the web image comprising a remote auto-set access mechanism;
activating the remote auto-set access mechanism of the web image showed by the web browser of the client end to drive a SSL VPN driver of the security gateway to establish a SSL VPN tunnel between the server end and the client end;
sending a certification data of the client end to the SSL VPN driver of the security gateway through the SSL VPN tunnel;
the SSL VPN driver sending the certification data to an IPSEC VPN driver of the security gateway;
the IPSEC VPN driver generating a security association (SA) based on the certification data, and then the SSL VPN generating information including the SA and sending the information to the client end via SSL VPN tunnel; and
establishing an IPSEC VPN tunnel between client end and the server end based on the SA set by the client end.

11. The method of claim 10, wherein the client end further comprises an IPSEC VPN gateway or an IPSEC VPN appliance program corresponding to the IPSEC VPN driver of the security gateway disposed at the server end.

12. The method of claim 11, wherein the web browser of the client end supports the SSL protocol so as to correspond to the SSL VPN driver of the security gateway.

13. The method of claim 12 further comprising: the remote auto-set access mechanism requesting the client end to input an ID authentication data by means of the web browser when activated, and sending the ID authentication data to the SSL VPN driver of the security gateway, wherein the ID authentication data comprises a password.

14. The method of claim 13, wherein ID authentication data of the client end is sent by means of the SSL VPN tunnel to the SSL VPN driver of the security gateway.

15. The method of claim 14, wherein the SSL VPN driver determines if the received ID authentication data is authorized so as to allow establishing an IPSEC VPN tunnel between the client end and the server end.

16. The method of claim 15, wherein if the ID authentication data is authorized, the SSL VPN driver requests the client end to send the certification data to the SSL VPN driver via the SSL VPN tunnel.

17. The method of claim 16, wherein the certification data comprises the Internet Protocol (IP) address of the client end, gold key or credential.

18. The method of claim 10, wherein the SSL VPN driver is a VPN driving firmware supporting the SSL protocol for protecting data-transmission over the application layer.

19. The method of claim 18, wherein the certification data from the SSL VPN driver is sent to the IPSEC VPN driver of the security gateway via a connection interface for protecting data transmission over the IP layer.

20. A method of SSL protocol protection for use in a security gateway, for use in a network system for linking at least client end and a server end, wherein the security gateway is at the server end, the method comprising:
generating a web image using a web browser of the client end through a user interface of the security gateway, the web image comprising a remote auto-set access mechanism for receiving an ID authentication data inputted by means of the web browser of the client end;
activating the remote auto-set access mechanism of the web image showed by the web browser of the client end to drive the SSL VPN driver of the security gateway;
establishing a SSL VPN tunnel between the server end and the client end, so that the ID authentication data of the client end is sent to the SSL VPN driver of the security gateway through the SSL VPN tunnel;
the SSL VPN driver determining if the received ID authentication data is authorized to establish an IPSEC VPN tunnel between the client end and the server end;
if the ID authentication data is authorized, requesting the client end to send a certification data to the IPSEC VPN driver of the security gateway via the SSL VPN tunnel, for establishing the IPSEC VPN tunnel;
the IPSEC VPN driver generating a security association (SA) based on the certification data, and sending the SA back to the client end via SSL VPN tunnel; and
the client end setting the SA and establishing an IPSEC VPN tunnel between client end and the server end.
